(19) United States
(12) Patent Application Publication
(10) Pub. No.: US 2018/0142159 A1
(43) Pub. Date: May 24, 2018

(54) SYNERGISTIC CO-PYROLYSIS OF BIOMASS AND METHANE FOR HYDROCARBON FUELS AND CHEMICALS PRODUCTION

(71) Applicant: The Board of Regents for Oklahoma State University, Stillwater, OK (US)

(72) Inventors: Ajay Kumar, Stillwater, OK (US); ZIXU YANG, STILLWATER, OK (US); ALLEN WALLACE APBLETT, Stillwater, OK (US)

(21) Appl. No.: 15/575,079

(22) PCT Filed: May 31, 2016
(86) PCT No.: PCT/US2016/035103

§ 371 Date: Nov. 17, 2017

Related U.S. Application Data
(60) Provisional application No. 62/168,166, filed on May 29, 2015.

(51) Int. Cl. C10G 1/02; B01J 29/48; B01J 37/02; B01J 37/08

(52) U.S. Cl. CPC C10G 1/02; B01J 29/48; B01J 37/0201; C10G 2300/1014; C10G 2400/30; C10G 2300/202; B01J 37/08

(57) ABSTRACT

There are provided herein novel catalytic approaches of producing deoxygenated bio-oil in fast pyrolysis reaction conditions. In one embodiment, HZSM-5 zeolite was modified by loading bimetallic catalyst compounds, resulting in new catalysts including MoAg/HZSM-5 and MoZn/HZSM-5. Both catalysts showed higher reactivity towards methane activation than molybdenum-only loaded catalysts. MoAg/HZSM-5 tended to catalyze dealkylation of alkylated benzenes thus yielded a product with high selectivity towards benzene. A dramatic increase in the yield of aromatic hydrocarbons was noticed when MoZn/HZSM-5 was used for catalysis of switchgrass under methane atmosphere. The final liquid hydrocarbons targeted according to this embodiment are benzene, toluene, ethylbenzene, xylene, naphthalene (BTEXN).

### CROSS REFERENCE TO RELATED APPLICATIONS

This application claims the benefit of U.S. Provisional Patent Application Ser. No. 62/168,166 filed on May 29, 2015 and incorporates said provisional application by reference into this document as if fully set out at this point.

### TECHNICAL FIELD

This disclosure relates generally to pyrolysis of biomass, activation/aromatization of methane and co-pyrolysis of biomass and methane and, more particularly, to systems and methods for production of deoxygenated bio-oil or hydrocarbons.

### BACKGROUND

Biomass fast pyrolysis holds promise for production of sustainable and environmentally friendly hydrocarbon fuels and chemicals. However, despite recent advances in biomass fast pyrolysis and bio-oil upgrading, converting unstable bio-oil into fuels and chemicals remains a major challenge. The problems with bio-oil are inherent in its high oxygen content, high acidity and instability. These properties, in turn, are the result of high oxygen content of its precursor biomass and non-equilibrium nature of fast pyrolysis process.

Lignocellulose biomass is a carbon-based renewable resource which has the potential to alleviate our dependence on fossil fuels and mitigate global warming and other environmental issues associated with the use of fossil fuels. Fast pyrolysis has been seen as a promising and sustainable route to convert solid biomass into liquid fuel. In this process, biomass is rapidly decomposed into vapors, aerosols and solid char thermochemically in the inert atmosphere at a mild temperature range (400˜600° C.), followed by a rapid condensation to recover a liquid product, which is 60-75 wt % of the biomass feed. Bio-oil can be combusted directly as a fuel in a burner for power generation, or used in engines or turbines. In addition, it can be further upgraded to transportation fuels and chemicals produced currently by petroleum refineries. However, bio-oil suffers from several negative attributes associated with its high oxygen content, such as low energy content, high viscosity, corrosiveness, thermal instability and immiscibility with petroleum fuels. These negative attributes of bio-oil pose significant challenges to the facilities in refineries and end users. Therefore, there is a critical need for developing effective techniques to enhance bio-oil properties so that it can be used in current refinery infrastructures and combustors.

One of the most common bio-oil upgrading techniques is removal of oxygen (deoxygenation) from the bio-oil. Most upgrading methods require heterogeneous catalysts to initiate reactions such as dehydration, decarboxylation, decarbonylation and hydrodeoxygenation, to convert raw bio-oil into a deoxygenated product. However, these upgrading process typically require multiple steps that increase the complexity of the overall process. Additionally, the need to maintain a high pressure of hydrogen increases cost. Therefore, catalytic fast pyrolysis (CFP) has emerged as a more economical and efficient process that can directly convert solid biomass into liquid hydrocarbons.

CFP combines biomass pyrolysis and catalysis in a single reactor system, where solid biomass is converted into hydrocarbons in the presence of inexpensive zeolite catalysts. This process can be operated at atmospheric pressure and without using any hydrogen. The selectivity of these petrochemicals during CFP increases with increasing H/C_{eff} ratio of the feed, which is defined in equation (1), where H, C, and O are the mole percent of hydrogen, carbon and oxygen in the feed. In addition, catalyst deactivation rate decreases with increasing H/C_{eff} ratio:

$$\frac{H}{{C}_{eff}} = \frac{H - 20}{C} \qquad ( 1 )$$

The H/C_{eff} ratio of biomass varies from about 0 to 0.3, which is not suitable for production of petrochemicals due to rapid deactivation of zeolites. Therefore, a hydrogen-rich donor can be co-fed into the reactor with biomass to increase the overall H/C_{eff} ratio.

Methane, the major component of natural gas, has the potential to be an ideal hydrogen donor in CFP of biomass for petrochemical production due to low cost and high H/C_{eff} of 4. Typically, methane can be converted into hydrocarbons through multiple steps: first, methane is converted into synthesis gases (H₂ and CO) via steam reforming or partial oxidation, and then further converted into fuels and chemicals via Fischer-Tropsch (FT) synthesis. This reaction route is highly energy intensive due to need of high reaction temperature and pressure, and also because FT hydrocarbon products have wide chain lengths that require further cracking and aromatization.

What is needed, then, is a system and method of reducing the cost of bio-oil production from biomass using methane as a hydrogen donor.

Before proceeding to a description of the present invention, however, it should be noted and remembered that the description of the invention that follows, together with the accompanying drawings, should not be construed as limiting the invention to the examples (or embodiments) shown and described. This is so because those skilled in the art to which the invention pertains will be able to devise other forms of this invention within the realm of the appended claims.

### SUMMARY OF THE INVENTION

There are provided herein novel catalytic approaches of producing deoxygenated bio-oil in fast pyrolysis reaction conditions. The final liquid hydrocarbons targeted according to this embodiment are benzene, toluene, ethylbenzene, xylene, naphthalene (BTEXN). The disclosure details a process to reduce cost of bio-oil production and upgrading without using any hydrogen.

The present disclosure includes a biomass upgrading process with the intervention of low-cost methane to produce aromatic hydrocarbons in the presence of bimetallic catalytic precursor impregnated into a protonated zeolite. As used herein, the term “bimetallic catalyst” is defined to be a catalyst for use in biomass pyrolysis that has two metal components, “M1” and “M2” (i.e., it takes the form M2M1) where M1, including (M1)ₙ, n=1,2, etc., is an oxide or carbonate compound of molybdenum, vanadium, or tungsten. M2, including (M2)ₙ, n=1,2, etc., is silver, zinc, a divalent transition metal or an alkaline earth metal. Also included could be mixtures of any of the foregoing. The preferred protonated zeolite is HZSM-5. The bimetallic catalyst might be formed from a single-source precursor.

To improve the performance of the co-catalysis of biomass and methane, HZSM-5 zeolite was modified by loading bimetallic catalyst precursor compounds, resulting in new catalysts. In preferred embodiments, MoAg/HZSM-5 and MoZn/HZSM-5, have been determined to be particularly suitable. Both preferred catalysts showed higher reactivity towards methane activation than molybdenum-only loaded catalysts. MoAg/HZSM-5 tended to catalyze dealkylation of alkylated benzenes thus yielded a product with high selectivity towards benzene. A dramatic increase in the yield of aromatic hydrocarbons was noticed when MoZn/HZSM-5 was used for catalysis under methane atmosphere.

Aqueous impregnation of biomass with single-source precursors for catalysts result in highly distributed catalysts in intimate contact with the biomass, enhancing the catalytic production of useful pyrolysis products. The use of single-source precursors that can be impregnated into the biomass via aqueous solution can result in high dispersion of the catalyst, maximized contact between the catalyst and the biomolecules and their decomposition products, and ultimately increase the efficiency of catalytic fast pyrolysis of biomass into biofuels. Carbon from both methane and the biomass are incorporated in the produced aromatics suggesting that appropriate catalysts that can activate methane can be used to co-condense biomass molecules to useful fuels.

According to one embodiment, there is provided a method of forming a catalyst for use in biomass pyrolysis. ZSM-5 zeolites in ammonium were calcined for a period of time sufficient to make a protonated form of HZSM-5. A precursor for Mo is, in this embodiment, (NH₄)₆Mo₇O₂₄.4H₂O, and is purified by recrystallization from water. The Mo species is impregnated on the HZSM-5 support using wet impregnation method. The HZSM-5 support is degassed under vacuum and then is impregnated with a solution containing ammonium heptamolybdate and ammonia. The mixture is then centrifuged and thereafter decanted. The centrifuge tubes are placed in a freezer to freeze the liquid within the pores of the zeolite. The samples are then freeze-dried on a lyophilizer. The resulting powder is then calcined in air to yield MoO₃/HZSM-5. The synthesis of Mo₂C/HZSM-5 catalyst follows the same procedure as MoO₃/HZSM-5 but uses a different precursor solution containing the same concentrations of ammonia heptamolybdate and ammonia but also contains hexamethylenetetramine (HMT). Unlike the MoO₃/HZSM-5, the Mo₂C/HZSM-5 is calcined in a flow of helium in this variation.

In an embodiment, there is provided a new catalyst and method of making same. The catalyst MoAg/HZSM-5 is prepared as follows. ZSM-5 zeolites (Si/Al=30, surface area=425 m²/g) in ammonium form were calcined in the air at 550° C. for 4 hrs to make protonated HZSM-5. MoAg/HZSM-5 bimetallic catalyst precursor was then synthesized by impregnating MoO₃/HZSM-5 (produced as described above and FIG. 6) with a solution of silver acetate (0.5 wt. %) for 24 hours. The catalyst was separated by centrifugation and then freeze dried followed by calcination at 700° C. FIG. 7 depicts the synthesis route of bimetallic MoZn/HZSM-5 catalyst. Additional details of the method of preparation can be found in A. M. Moneeb, A. M. Alabdulrahman, A. A. Bagabas, C. K. Perkins, A. W. Apblett, “Bimetallic single-source precursor for the synthesis of pure nanocrystalline room temperature-stabilized β-NiMoO 4”, Ceramics International, 42 (2016) 1366-1372, the disclosure of which is incorporated herein by reference as if fully set out at this point. Then, the catalyst sample was freeze dried and calcined in a flow of helium at 700° C. for 2 h.

In some embodiments, bimetallic catalysts (e.g., MoAg/HZSM-5 and MoZn/HZSM-5) are also useful in methods of biomass pyrolysis. These catalysts are generally more effective in catalyzing methane activation than Mo-only loaded (MoO3/HZSM-5 and Mo2C/HZSM-5) catalysts. In the present embodiment, the aromatic yield is positively related to the contents of cellulose, hemicellulose and negatively related to the lignin in biomass samples.

According to an embodiment, molybdenum modified HZSM-5 catalysts in a methane atmosphere were found to promote deoxygenation of lignin-derived phenols, resulting in more simple aromatics. Catalysis with the intervention of methane was performed in presence of molybdenum modified bimetallic catalysts, MoAg/HZSM-5 and MoZn/HZSM-5. Bimetallic catalysts demonstrated a higher reactivity towards methane activation. Catalysis of biomass with the intervention of cheap methane is a promising biomass upgrading technology.

There is also provided herein a process for producing bio-oil from a biomass that uses low-cost methane to produce aromatic hydrocarbons in presence of bimetallic catalyst precursor modified HZSM-5 zeolite catalyst. HZSM-5 zeolite was modified by loading bimetallic catalyst precursor compounds. In a preferred embodiment, HZSM-5 zeolite was modified by loading bimetallic molybdenum-containing compounds. Bimetallic molybdenum modified HZSM-5 zeolite catalysts showed higher reactivity towards methane activation than molybdenum-only loaded catalysts. MoAg/HZSM-5 tended to catalyze dealkylation of alkylated benzenes thus yielded a product with high selectivity towards benzene. A dramatic increase in the yield of aromatic hydrocarbons was noticed when MoZn/HZSM-5 was used for catalysis of switchgrass under methane atmosphere.

There is also provided a method of production of bio-oil that utilizes high temperature pyrolysis in a methane atmosphere in the presence of a catalyst such as the foregoing. Pyrolysis conditions, such as reaction temperature and heating rate, and feedstock types have significant effects on the distribution and composition of pyrolysis products. Torrefaction may, in some cases, enhance the production of sugar-based compounds and phenols during pyrolysis. Densification enhanced the degradation of carbohydrate components in biomass feedstock thus yielded more secondary pyrolysis products, such as furans, ketones and acetic acids. High pyrolysis temperatures, where high temperatures are defined to be 600° C.-1,000° C. and most suitably about 700° C., enhanced decomposition of lignin and anhydrous sugars, leading to increase in phenols, aromatics and furans. Densification enhanced depolymerization of cellulose and hemicellulose during pyrolysis.

In one embodiment, the invention of the present disclosure includes a catalyst for the pyrolysis of biomass comprising a bimetallic catalyst impregnated onto a protonated zeolite, wherein the bimetallic catalyst comprises a first metal component and a secondary metal component. The first metal component may be molybdenum oxide or carbonate; vanadium oxide or carbonate; or tungsten oxide or carbonate. In a particular embodiment, the first metal component is molybdenum oxide or molybdenum carbonate. The secondary metal component may be zinc, silver, a divalent transition metal or an alkaline earth metal. Zinc is a particularly suitable secondary metal component. The protonated zeolite is preferably protonated ZSM-5.

It has been determined that MoAg/HZSM-5 and particularly MoZn/HZSM-5 are suitable catalysts according to the present disclosure.

Another aspect of the disclosure includes a method of preparing a catalyst for use in the pyrolysis of biomass. The method comprises: a) preparing a protonated form of zeolite ZSM-5; b) impregnating the protonated zeolite ZSM-5 with a bimetallic catalyst; and c) calcining the impregnated protonated zeolite ZSM-5, thereby producing the catalyst. The bimetallic catalyst may comprise a first metal component and a secondary metal component. The first metal component may be molybdenum oxide or carbonate; vanadium oxide or carbonate; or tungsten oxide or carbonate. A particularly suitable first metal component is molybdenum oxide or molybdenum carbonate. The bimetallic catalyst may be in an aqueous solution. The secondary metal component may be zinc, silver, a divalent transition metal or an alkaline earth metal. Zinc is a particularly suitable secondary metal component.

A third aspect of the present disclosure includes a method for producing bio-oil from a biomass, comprising co-pyrolyzing the biomass and methane at a high temperature in the presence of a catalyst. The catalyst may be a molybdenum oxide or molybdenum carbide impregnated onto a protonated zeolite. The protonated zeolite is protonated ZSM-5. The catalyst may in another embodiment be a bimetallic catalyst impregnated onto a protonated zeolite. The zeolite may be protonated ZSM-5. Particularly suitable catalysts are MoAg/HZSM-5 and particularly MoZn/HZSM-5.

Yet another aspect of the present disclosure includes a method for producing bio-oil from a biomass comprising the step of pyrolyzing the biomass in the presence of a catalyst, wherein the catalyst is a bimetallic catalyst impregnated onto a protonated zeolite. Particularly suitable bimetallic catalysts are MoAg/HZSM-5 and particularly MoZn/HZSM-5. The bimetallic catalyst may be aqueously impregnated onto the zeolite. The bimetallic catalyst of the present disclosure is preferably formed from a single source precursor.

The foregoing paragraphs have outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 contains exemplary reaction mechanisms for methane aromatization.

FIG. 2 contains one example of a reaction pathway during co-pyrolysis of biomass and methane over HZSM-5.

FIG. 3 contains an illustration of the effects of torrefaction on the product distribution obtained from catalytic pyrolysis of switchgrass (RSG is raw switchgrass; T230 is switchgrass torrefied at 230° C.; 1:1 is biomass: catalyst).

FIG. 4 contains a plot of the effects of torrefaction temperature on the product distribution obtained from catalytic pyrolysis of torrefied switchgrass with Mo/ZSM-5 (T230/270 is switchgrass torrefied at 230/270° C.; 1:5 is biomass: catalyst) for an embodiment.

FIG. 5 shows the effects of atmosphere on the product distribution obtained from catalytic pyrolysis of furan with Mo/ZSM-5 (left bar: pyrolysis products obtained under helium; right bar: pyrolysis products obtained under methane).

FIGS. 6A and 6B contain illustrations of methods of catalyst synthesis.

FIG. 7 contains an illustration of a method of bimetallic catalyst synthesis.

FIGS. 8a-8f show the effects of pyrolysis temperature on BTEXN obtained from catalytic pyrolysis of torrefied switchgrass with Mo/ZSM-5 under helium and methane (HE is helium, ME is methane).

FIG. 9 illustrates an embodiment of a method of producing bio-oil using a bimetal protonated zeolite catalyst.

FIG. 10 illustrates an embodiment of a method of producing bio-oil using a bimetal protonated zeolite catalyst in the presence of methane.

### DETAILED DESCRIPTION

While this invention is capable of embodiment in many different forms, there is shown in the drawings, and described hereinafter in detail, some specific embodiments of the instant invention. It should be understood, however, that the present disclosure is to be considered an exemplification of the principles of the invention and is not intended to limit the invention to the specific embodiments or algorithms so described.

One-step methane dehydroaromatization using metal modified ZSM-5 catalysts is an attractive way to produce selected aromatic hydrocarbons, where ZSM-5 (Zeolite Socony Mobil-5,) is a well known aluminosilicate zeolite belonging to the pentasil family of zeolites. Its chemical formula is NaₙAlₙSi₉₆₋ₙO₁₉₂.16H₂O (0<n<27).

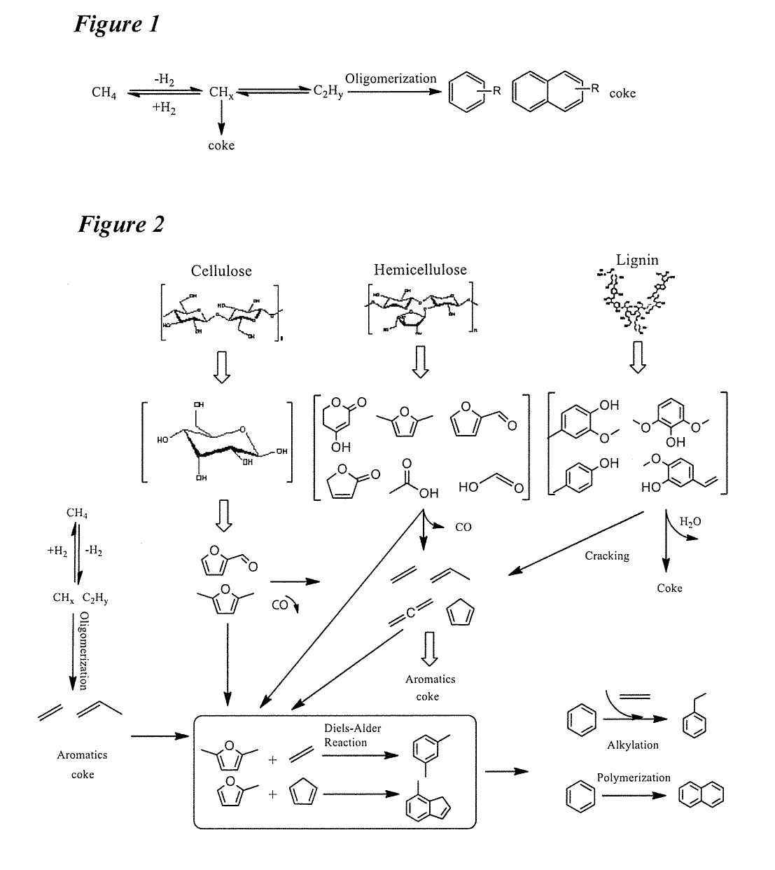

The reaction mechanism of methane aromatization/activation with metal zeolites occurs in two steps as indicated in FIG. 1. Initially, methane molecules activates into intermediate radicals such as CHₓ (x<4), H., C₂H_{y}⁺ (y=3, 5) on metal sites, and then these radicals oligomerizes to olefins or aromatics on the acidic sites of zeolites. Thermodynamic analysis has shown an increasing trend of coke deposition as the methane conversion increased. Carbon deposition on catalysts is considered to be a challenging problem in methane aromatization.

Torrefaction is a slow pyrolysis process that, occurs in the temperature range of 200˜300° C. During torrefaction, biomass partially decomposes and releases most of the moisture and a portion of some other volatiles, resulting in a hydrophobic solid product with improved physical and chemical properties, grindability and increased energy density. Under a torrefaction temperature range from 240 to 320° C., hemicellulose was the major component that reacted, cellulose began to decompose at 280° C., while lignin content was concentrated as the temperature of torrefaction increased.

Torrefaction has been shown to increase deoxygenated compounds such as simple phenols and sugars, whereas oxygenated phenols such as guaiacols and small oxygenated compounds such as furans and acids were decreased. Torrefaction can be an effective thermal pretreatment to improve the selectivity towards aromatic hydrocarbons over ZSM-5 catalysts. Torrefaction temperatures (270 or 300° C.) led to a significant decrease of aromatic compounds and an increase of coke yield. It has also been shown in studies involving the aromatics production via a catalytic pyrolysis using torrefied biomass components over ZSM-5 catalysts with varying acidity, cellulose and lignin, and it was found that higher acidity of the ZSM-5 resulted in higher aromatics yield for both torrefied cellulose and lignin. The glycosidic bonds connecting monomers of cellulose were partially cleaved due to torrefaction process, leading to an open chain structure that could be further converted into aromatics.

One embodiment may be modeled by via the reaction pathways that are shown in FIG. 2. Cellulose, hemicellulose and lignin depolymerize into anhydrous sugars, furans and guaiacols during primary pyrolysis, respectively. Methane activates into radicals and then these radicals undergo oligomerization to form olefins, aromatics, and coke. The olefins may react with furans through Diels-Alder condensation to produce aromatics. Furthermore, the produced aromatics can be alkylated by surplus olefins on the acidic sites of HZSM-5. The end product of lignin is phenol, which cannot be further deoxygenated over HZSM-5.

Aqueous impregnation of biomass with single-source precursors for catalysts may lead to highly distributed catalysts in intimate contact with the biomass, enhancing the catalytic production of useful pyrolysis products. There are several possible catalysts. Representative examples include: catalysts capable of non-oxidative coupling of methane (e.g. La₂O₃—CeO₂ and Mn₂O₃), selective oxidation of methane (MMoO₄ and M₂V₂O₇ where M is, for example, Co, Fe, Mg, and Mn), activation of methane by protonation (using acidic catalysts such as, for example, sulfated zirconia and silicomolybdic acid) and dehydrogenative activation of methane (e.g. with Mo₂C, mixed metal carbides, MoS₂) are included in this category. Results with manganese oxide and ferric molybdate catalyst precursors support this disclosure. These catalysts react with biomass and intermediate biomass pyrolysis products. More generally, catalysts using bimetallic oxides of cobalt, iron, magnesium, manganese, zinc, etc., would be expected to be effective as well. Preferably, these catalysts will be carried on zeolite, but that is not an absolute requirement as they could be used as-is or be carried on another medium.

Zeolite catalysts, also known as molecular sieves, have been shown to have a significant catalytic effect on the conversion of biomass pyrolysis vapors into hydrocarbons, such as BTEX (i.e., benzene, toluene, ethylbenzene and xylenes). The Bronsted acid sites of the molecular sieve ZSM-5 donate protons to the hydroxyl group of oxygenates to instigate dehydration reactions. Transition metal modified ZSM-5 catalysts, such as Cu/HZSM-5, Zn/HZSM-5, Ga/HZSM-5 on the catalyst framework can increase the acidity of the support material, leading to higher aromatic yields than HZSM-5 catalyst. Methane aromatization is a dehydrogenation process for which the HZSM-5 catalyst has been widely used. By far the most studied catalysts for methane aromatization are molybdenum based zeolite catalysts, such as Mo/HZSM and Mo/MCM-22t, because molybdenum based catalysts promote Diels-Alder reactions between olefins and alkenes and the aromatization of methane.

More generally, various embodiments utilize bimetallic oxides, preferably carried on zeolite. By way of example only, bimetallic oxides such as cobalt, iron, magnesium, manganese, and zinc are all potentially useful in the instant process.

According to one aspect of the present disclosure, and pursuant to FIG. 6, there is provided a method of preparing a catalyst for use in hydrocarbon fuels and chemicals production. In FIG. 6A 1, ZSM-5 zeolites 600 (Si to Al molar ratio of 30 and nominal surface area of 425 m²/g) in ammonium were calcined in air at 550° C. for 4 h to 5 h (step 602) to make protonated form of HZSM-5 604. The precursor for Mo was (NH₄)₆Mo₇O₂₄.4H₂O, and was purified by recrystallization from water. The Mo species were impregnated on the HZSM-5 support using an incipient wetness impregnation method. One gram of HZSM-5 support 604 was degassed under vacuum for 24 h and then was impregnated at 608 with a solution containing ammonium heptamolybdate (3.5 wt %) and ammonia (1.4 wt %) for 16 h at room temperature (box 606). Ammonia was added to prevent the ammonium heptamolybdate from precipitating within the HZSM-5 to form molybdic acid. After 16 h, the mixture 610 was centrifuged to separate the solid. The supernatant liquid was then decanted and the centrifuge tubes were placed in a −25° C. freezer for 5 h to freeze the liquid within the pores of the zeolite. The samples were then freeze-dried on a lyophilizer for 24 h. The resulting powder was then calcined at 612 in air at 550° C. for 4 h to yield MoO₃/HZSM-5 (box 614).

Pursuant to FIG. 6B, the synthesis 618 of Mo₂C/HZSM-5 catalyst 618 followed the same procedure as MoO₃/HZSM-5 but used a different precursor solution 620 as described by Wang et al (H.-M. Wang, X.-H. Wang, M.-H. Zhang, X.-Y. Du, W. Li, K.-Y. Tao, Synthesis of bulk and supported molybdenum carbide by a single-step thermal carburization method, Chem. of Materials, 19 (2007) 1801-1807), the disclosure of which is incorporated herein by reference as if fully set out at this point. This precursor solution contained the same concentrations of ammonia heptamolybdate and ammonia but also contained 3.8% by weight of hexamethylenetetramine (HMT), box 620. Unlike the MoO₃/HZSM-5, the Mo₂C/HZSM-5 was calcined at 700° C. for 2 h in a flow of helium shown at 624, to produce Mo₂C/HZSM5 (box 618).

According to another approach, ZSM-5 zeolites (Si to Al molar ratio of 30 and nominal surface area of 400 m²/g) were calcined in the air at 550° C. for 4 hours to convert into protonated form HZSM-5. Molybdenum was impregnated on the HZSM-5 support using incipient wetness impregnation. The precursor for molybdenum was ammonium heptamolybdate tetrahydrate. HZSM-5 support was mixed with an aqueous solution of the precursors so that 6 wt % of metal was loaded on the HZSM-5 support. Then the mixtures of HZSM-5 and aqueous solutions were stirred for 1 hour and then impregnated at room temperature for 16 hours. After drying the mixtures at 120° C. for 5 hours, the mixtures were calcined in the air at 550° C. for 4 hours.

In another embodiment, a MoAg/HZSM-5 catalyst is prepared as follows. ZSM-5 zeolites (Si/Al=30, surface area=425 m²/g) in ammonium form, and calcined in the air at 550° C. for 4 hrs to make protonated HZSM-5. MoAg/HZSM-5 was synthesized by impregnating MoO₃/HZSM-5 with a solution of silver acetate (0.5 wt. %) for 24 h. The catalyst was separated by centrifugation and then freeze dried followed by calcination at 700° C. Then, the catalyst sample was freeze dried and calcined in a flow of helium at 700° C. for 2 h. Additional details of the method of preparation can be found in A. M. Moneeb, A. M. Alabdulrahman, A. A. Bagabas, C. K. Perkins, A. W. Apblett, “Bimetallic single-source precursor for the synthesis of pure nanocrystalline room temperature-stabilized β-NiMoO 4”, Ceramics International, 42 (2016) 1366-1372, the disclosure of which is incorporated herein by reference as if fully set out at this point.

According to an embodiment, there are provided new approaches that combine torrefaction pretreatment and co-pyrolysis of biomass and methane in presence of catalysts to increase the aromatics yields. Both torrefaction pretreatment and co-feed methane will improve the H/Ceff ratio of the feedstock, which would result in high aromatics yield.

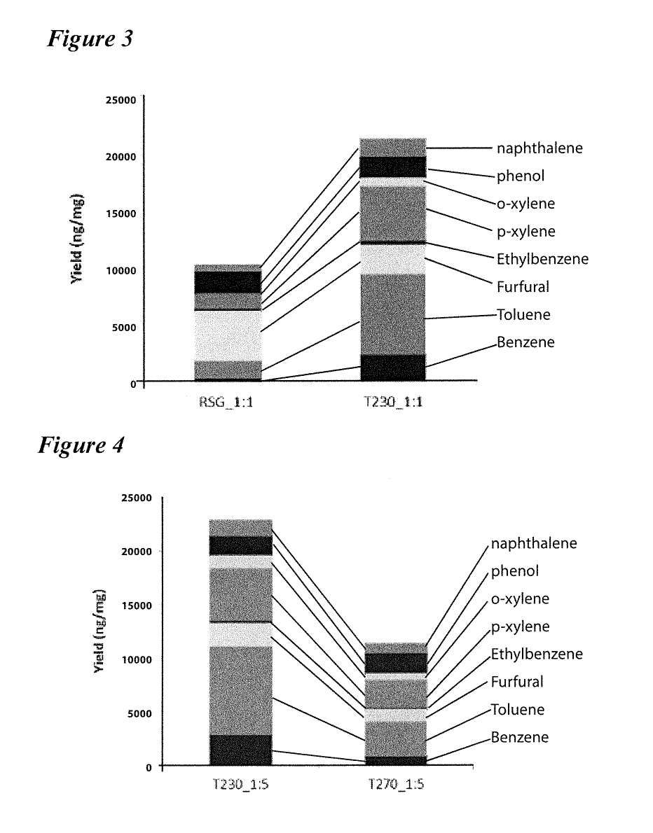

As exemplified in FIG. 3, dehydrative aromatization of biomass can also produce BTEX compounds suggesting that augmentation of this process can enhance the overall conversion of biomass to useful fuels. The use of single-source precursors that can be impregnated into the biomass via aqueous solution can result in high dispersion of the catalyst, maximized contact between the catalyst and the biomolecules and their decomposition products, and ultimately increase the efficiency of catalytic fast pyrolysis of biomass into biofuels. Carbon from both methane and the biomass are incorporated in the produced aromatics suggesting that appropriate catalysts that can activate methane can be used to co-condense biomass molecules to useful fuels.

One catalyst for oxidative coupling of methane is La₂O₃—CeO₂ that produces mainly ethylene and ethane along with smaller amounts of C3 and C4 hydrocarbons. A mixture of lanthanum gluconate and cerium gluconate can be utilized to produce this catalyst in-situ. The choice of gluconates is made on the premise that they are highly water-soluble and they crystallize with tremendous difficulty making it possible to easily prepare homogeneous solid solutions of mixed metal gluconates that are excellent precursors for multi-metallic oxides. Furthermore, the gluconates as glucose-derivatives can be expected to be very compatible with and bind strongly to cellulose and hemicellulose.

Manganese oxides are also capable of converting methane to higher hydrocarbons and can be simply derived from pyrolysis of manganese gluconate. Impregnation of switchgrass with a solution of manganese (II) gluconate followed by drying and then pyrolysis produced substantially increased amounts of aromatic compounds with a concomitant reduction in the amounts of anhydrous sugars. Furthermore, under a methane atmosphere the aromatic compounds were further increased in comparison to pyrolysis under helium suggesting that incorporation of methane into the aromatic products occurred. Also, the possibility of promotion of the reactivity of the manganese oxide with potassium oxide is possible by the addition of sufficient potassium gluconate to the impregnation solution.

A second approach to methane activation is selective oxidation to such species as methanol or formaldehyde. For example, an iron molybdate catalyst is effective for producing methanol. The first step of this reaction is addition of an oxygen atom to methane with concomitant reduction of the metal oxide catalyst. In the second step the catalyst is reoxidized by oxygen—a step that cannot occur in a biomass pyrolysis reactor. Instead, it is possible that deoxygenation of oxygenated molecules from the biomass might occur or reduction of water to produce hydrogen takes place. For example, when a single source precursor for iron molybdate was impregnated as an aqueous solution into switchgrass, a significant increase in aromatic compounds was observed as compared to the uncatalyzed pyrolysis while anhydrous sugars and guaiacols were decreased. Notably, the yield of aromatics was enhanced in a methane atmosphere.

A series of single-source precursors for selective oxidation and oxidative dehydrogenation catalysts have been produced based on metal vanadates and metal molybdates catalysts. These are produced by reaction of a metal gluconate with either molybdenum trioxide or vanadium pentoxide. Single source precursors for MMoO₄ and M₂V₂O₇ (M=Co, Fe, Mg, and Mn) and MoO₃ and V₂O₅ catalysts can be prepared and used for impregnating biomass with the corresponding catalysts.

The active catalyst in the Mo/ZSM-5 catalyst for conversion of methane to benzene is believed to be Mo₂C. While Mo₂C might be expected to behave differently outside of the zeolite, it is likely that it will be active in methane activation when dispersed on a biochar support. This can be realized by use of a single source precursor for Mo₂C such as, for example, a hexamethylenetetramine heptamolybdate salt that produces Mo₂C upon pyrolysis in an inert atmosphere. The precursor is water-soluble and can readily be incorporated into the biomass by aqueous impregnation.

With respect to the effectiveness of certain catalysts, the total carbon yield of aromatics varied across different HZSM-5 supported catalysts, with a low of 16.63±2.09% for MoO₃/HZSM-5 under inert atmosphere and a maximum of 35.00±4.37% for HZSM-5 under inert atmosphere. Tukey's multiple comparison showed that pyrolysis atmosphere (helium and methane) had no significant effect on the yield of individual aromatic groups and total aromatic hydrocarbons. ANOVA analysis revealed that the performance of the three HZSM-5 supported catalysts was different. MoO₃/HZSM-5 yielded the lowest amount of aromatic hydrocarbons, whereas HZSM-5 support yielded the highest amount of aromatics. However, the difference between HZSM-5 support and Mo₂C/HZSM-5 was not significant in this case.

Considering the aromatics selectivity of products, namely benzene, toluene, ethylbenzene, p/o-Xylene, benzene derivatives and polyaromatics from cellulose under helium and methane atmospheres, the HZSM-5 supported catalysts have high selectivity (up to 70%) towards BTEX. Among all the aromatics, the selectivity for toluene was the highest for all of the catalysts tested, with a maximum of 32.87% with MoO₃/HZSM-5 under helium. The pyrolysis environment did not have significant impact on the selectivity for aromatic. However, the impacts of Mo impregnation on aromatics selectivity were noticeable. With MoO₃/HZSM-5, the selectivity for polyaromatics significantly decreased, whereas selectivities for the benzene and toluene increased significantly as compared for the other two HZSM-5 supported catalysts. Polyaromatics are commonly viewed as indicators for coke formation that may lead to catalyst deactivation during catalytic fast pyrolysis. By comparing aromatics yield and selectivity, it can be concluded that HZSM-5 deactivated during impregnation with MoO₃. Generally, there are three common reasons to account for catalyst deactivation: (1) poisoning of active sites by catalyst coking; (2) blockage of pores by catalyst coking; (3) reduction in number/strength of active sites In this case, MoO₃/HZSM-5 showed the lowest selectivity towards polyaromatics, indicating low tendency towards coking. Therefore, the low catalytic reactivity of MoO₃/HZSM-5 could be attributed to the reduction in acidity of HZSM-5 support during impregnation. To verify this assumption, the MoO₃/HZSM-5 catalyst was treated with a solution of nitric acid followed by calcination. After acidification, the catalytic reactivity was restored.

In this embodiment of catalytic pyrolysis of hemicellulose, the total aromatics yield from hemicellulose was significantly lower than that from cellulose. For instance, the carbon yield of total aromatics from cellulose and hemicellulose in the presence of HZSM-5 under helium was 35.00±4.37 and 19.48±1.26%, respectively. These values are in good agreement with those reported in the literature. Although both cellulose and hemicellulose are carbohydrates, hemicellulose is thermally less stable than cellulose. Therefore, the cracking of hemicellulose in the presence of a zeolite is easier than that of cellulose. This is confirmed from the high yield of gaseous products from the catalytic pyrolysis of hemicellulose reported in other studies. Similar to the results of cellulose, methane shows no significant effects in improving the yield of aromatics of hemicellulose.

Continuing with the present example, all of the HZSM-5 supported catalysts yielded product compositions with the selectivity of BTEX up to 70%. The maximum BTEX selectivity of 79.14% was achieved when MoO₃/HZSM-5 was used under methane environment. Cellulose and hemicellulose yielded similar selectivities for toluene, ethylbenzene and polyaromatics. Variations were noticeable in the yields of benzene, xylene and benzene derivatives from cellulose and hemicellulose. The selectivity of benzene and benzene derivatives was lower for hemicellulose than that for cellulose. However, the selectivity for xylene showed opposite trend. For example, benzene selectivity dropped from 17.58 to 14.41%, xylene selectivity increased from 17.67 to 23.01%, and benzene derivatives selectivity decreased from 12.29 to 11.36% when hemicellulose was used instead of cellulose. The introduction of methane had an impact on the formation of some of the aromatic compounds. The benzene selectivity under methane was slightly higher than that under helium, and this difference was significant (p<0.05) with MoO₃/HZSM-5 and Mo₂C/HZMS-5 as the catalysts. In contrast, the selectivity of benzene derivatives under methane was slightly lower than that under helium, and the difference was significant with HZSM-5 and MoO₃/HZSM-5 catalysts. The impacts of impregnated Mo species on formation of aromatics for hemicellulose were similar to that observed for cellulose. No significant differences in aromatic yields were observed between HZSM-5 support and Mo₂C/HZSM-5. However, MoO₃/HZSM-5 did yield more toluene and benzene and less polyaromatics than the HZSM-5 and Mo₂C/HZSM-5 catalysts.

In an example involving the catalytic pyrolysis of lignin, the total carbon yields of lignin were even lower than those of hemicellulose. The rank order of three biomass constituents in terms of yielding aromatics was cellulose>hemicellulose>lignin, which is consistent with other results reported. Also, it should be noted that the oxygenate yield from lignin was significantly higher than that from either cellulose or hemicellulose. Lignin is primarily depolymerized into phenolic compounds during pyrolysis. The low reactivity of these phenols in HZMS-5 is responsible for the high yield of oxygenates from lignin. Methane slightly increased the yield of BTEX, polyaromatics and total aromatics but the change was not statistically significant. MoO₃/HZSM-5 had the lowest aromatics yield among all three catalysts. This is likely due to deactivation during catalyst impregnation as discussed above.

The selectivity of polyaromatics from lignin was the highest among biomass components. The maximum polyaromatics selectivity from lignin reached up to 36% in the presence of HZMS-5, while the selectivity was only 20% from cellulose and hemicellulose. This variation could also be attributed to the conversion of the lignin-derived phenols into polyaromatics and coke through polycondensation in the channel of HZSM-5. Effect of methane was only significant on the selectivity of benzene and benzene derivatives with HZSM-5. However, the carbon yields of lignin-derived BTEX and polyaromatics under methane were higher (but not significant) than those under Helium. Also, impregnation with the Mo species significantly changed the selectivity of aromatics. In general, the presence of Mo increased selectivity of BTEX and decreased selectivity of polyaromatics.

Transition metals such as Ni, Co, and Mo have shown to catalyze deoxygenation of phenolic compounds to form aromatics leading to their widespread use in hydrodeoxygenation (HDO) of bio-oil compounds. Rather than ending up as polyaromatics and coke in the channels of HZSM-5, lignin-derived phenolic compounds may have incorporated into the active sites of the Mo species, where hydroxy and methoxy groups, possibly, directly stripped from the aromatic rings. Mo₂N/Al₂O₃ exhibited a high selectivity of monocyclic aromatics and an extremely low selectivity of polyaromatics (2.2%) from lignin.

In connection with the current disclosure, Mo impregnated HZSM-5 acted as a bifunctional catalyst: Mo species provided active sites for deoxygenation and the Lewis and Bronsted acid sites in HZSM-5 were responsible for the aromatization of lignin-derived olefins. The increase in BTEX selectivity and decrease in polyaromatics is the synergistic result of these two mechanisms.

Added methane significantly increased aromatic hydrocarbon yield from lignin but did not significant effect the aromatic hydrocarbon yield from cellulose and hemicellulose. Even with only HZSM-5 support, the carbon yield of aromatics obtained with methane was higher than that obtained under helium. These results suggest that methane can incorporate into lignin derived phenols directly and form aromatics through HDO without being activated on the active sites on Mo species. Lignin-derived intermediates, such as guaiacols and phenols can be converted into aromatics through a series of reactions like dehydration, demethylation and transalkylation that occur in the HDO process.

Torrefied switchgrass showed higher H/C and lower O/C as compared to raw switchgrass. The three major biomass constituents (cellulose, hemicellulose and lignin) behaved differently under thermal pretreatment due to their different thermal stabilities. Typically, hemicellulose is the least stable under thermal pretreatment, whereas lignin is the most stable. Hemicellulose was the major component that decomposed during torrefaction (at 240-320° C.), and cellulose began to decompose at 280° C., while lignin concentrated as the temperature of torrefaction increased.

Of particular interest for purposes of an embodiment is a non-oxidative direct methane aromatization (DMA) process that selectively converts methane into aromatic hydrocarbons, especially BTEX in presence of bifunctional zeolite catalysts. Transition metal based catalysts like tungsten (W) and molybdenum (Mo) are considered as the most promising components for DMA. The metal components are responsible for the hydro/dehydrogenation and the acid sites provided by zeolites are responsible for the aromatization. During the DMA process, there is an initial stage that is crucial for the activation of methane, also known as “the introduction period” during which molybdenum oxides are reduced to more active components like molybdenum carbide (Mo₂C) or Molybdenum oxycarbide (MoCₓO_{y}). Molybdenum carbide species, formed through the partial reduction of molybdenum oxide are believed to be involved with the cleavage of C—H bonds, resulting in methyl radicals, which can undergo oliomerization and cyclization reactions on acid sites of zeolites to form aromatics.

Addition of oxygenates (CO, CO₂, NO) have also significantly improved the efficiency of the catalysts by mitigating the carbon deposition issues. A mechanism was proposed that the intermediate radicals, such as CHₓ (x<4), H. and C₂H_{y}⁺ (y=3, 5) degraded from methane, combined with free radicals, released from thermal cracking of coals, and formed aromatics on the acid site of HZSM-5 catalysts via dehydration, decarboxylation and oglimerization. Besides, methane conversion has been proven to increase significantly in the presence of higher hydrocarbons, especially unsaturated hydrocarbons, at a low temperature (400˜600° C.) and atmospheric pressure over HZSM-5 catalyst loaded with Zn or Ag.

Pyrolysis was performed in a commercialized pyrolyzer, which was connected to a gas chromatograph/mass spectrometer. For the sample loading, the biomass sample was sandwiched between two catalyst layers. The biomass sample and catalyst layers were separated by quartz wool so that only pyrolysis vapors of biomass sample would pass through the catalyst layers.

Quantification of targeted compounds was performed after calibration by injecting different known concentrations of working standards into the GC/MS. The carbon yield and selectivity were calculated using

$$Carbon yield = \frac{Moles of carbon in specific species}{Moles of carbon in biomass models}$$

$$Carbon selectivity = \frac{Moles of carbon in specific species}{Moles of carbon in all quantified species}$$

The effects of molybdenum modified HZSM-5 catalysts (HZSM-5, MoO₃/HZSM-5, Mo₂C/HZSM-5, MoAg/HZSM-5 and MoZn/HZSM-5), pyrolysis temperature (400, 500, 600, 700 and 800° C.) and torrefaction pretreatment (no torrefaction, torrefaction at 230° C. and torrefaction at 270° C.) were investigated individually using single factor design. The experiments were performed under helium and methane atmospheres.

The composition of switchgrass was significantly affected by torrefaction. As the torrefaction temperature increased, the content of cellulose and hemicellulose decreased significantly. The degradation of cellulose was approximately correlated with torrefaction temperature. However, the degradation of hemicellulose was drastic even at lower torrefaction, for example, the xylan content dropped from 26.34 to 7.58 wt. %. It is known that hemicellulose, the most unstable content in biomass, decomposes rapidly at the temperature range of 220-315° C. The lignin content increased steadily as the torrefaction temperature increased, showing that lignin is the most stable component during torrefaction, thus its content increases due to rapid loss of carbohydrates.

Products of catalytic pyrolysis of raw switchgrass are mostly aromatic hydrocarbons, which can be grouped into BTEX, benzene derivatives (alkyl benzenes, indane and indenes) and polyaromatics (naphthalenes, fluorene and anthracene). The maximum carbon yields of BTEX (27.27%) and total aromatics (39.31%) were obtained using MoZn/HZSM-5 under methane atmosphere. The catalytic pyrolysis was also performed using only methane in presence of Mo-modified HZSM-5 zeolites. The results indicated that the higher aromatics yield from catalytic pyrolysis of switchgrass under methane was due to the synergistic effect of methane and biomass-derived vapors in presence of Mo-modified HZSM-5 zeolites. The reactivity of individual molybdenum catalyst towards co-catalysis of biomass and methane was revealed by comparing the pair of values associated with helium or methane.

When methane is introduced in the feed, the carbon yield of aromatics increased in presence of HZSM-5, MoO₃/HZSM-5, MoAg/HZSM-5 and MoZn/HZSM-5 compared with the aromatics carbon yield obtained using the same catalyst under helium atmosphere. However, statistically the improvement in aromatics carbon yield due to methane is significant with MoZn/HZSM-5, and in this case the aromatic carbon yield and BTEX carbon yield increased from 29.53% and 20.06% (without methane) to 39.31% and 27.27% (with methane), respectively.

It is also worth noting that the impregnation of molybdenum species varied the reactivity of HZSM-5 catalyst. In general, the reactivity of catalysts with molybdenum loading (e.g. MoO₃/HZSM-5 and Mo₂C/HZSM-5) reduced compared with that of only support. However, when the support is loaded with bimetallic molybdenum species, such as MoAg/HZSM-5 and MoZn/HZSM-5, the catalytic reactivity recovered or even further improved. In detail, the carbon yields of BTEX obtained with MoAg/HZSM-5 under helium and methane were 17.01 and 20.27%, respectively, which were similar to that obtained in presence of support only. And, the carbon yields of BTEX obtained in presence of MoZn/HZSM-5 (helium: 20.06%, methane: 27.27%) were higher than that obtained in presence of HZSM-5 (helium: 17.24%, methane: 21.22%). The difference in catalytic reactivity of Mo-loading and bimetallic catalysts indicated that single Mo species did not effectively activate methane. Also, the carbon yield of polyaromatics obtained with both Mo-loaded and bimetallic HZSM-5 catalysts were lower than that obtained with the support only. Carbon yields of oxygenates, which include mainly phenolic compounds, were low (varying from 0.76% with HZSM-5 to 1.59% with MoZn/HZSM-5).

Production of aromatic hydrocarbons from biomass involves a series of acid-catalyzed dehydration, decarboxylation, and decarbonylation, followed by oligomerization in the channel of zeolite. As a result, the biomass oxygen is removed in the form of H₂O, CO₂ and CO. The maximum theoretical carbon yield of aromatic hydrocarbons can be achieved when only dehydration and decarboxylation occur. The theoretical yield of aromatics, which is characterized as CH_{1.2} from switchgrass can be derived via the following equation:

nCH_{1.68}O_{0.697}(RSG) [symbol] 0.824nCH_{1.2}+0.176nCO₂+0.345nH₂O

In one embodiment, the maximum aromatics carbon yield obtained from switchgrass under helium was 29.53%, which corresponds to 35.8% of the theoretical carbon yield. When methane is introduced, the theoretical carbon aromatics yield increases because all carbon in the feedstocks (biomass and methane) can be theoretically converted into aromatic products, while oxygen is removed as H₂O:

nCH_{1.68}O_{0.697}(RSG)+0.32nCH₄ [symbol] 1.32nCH_{1.2}+0.69nH₂O

The theoretical aromatics carbon yield obtained from switchgrass increases by approximately 60% through intervention of methane. According to one embodiment, the maximum aromatics carbon yield obtained under methane was 39.31%, which correspond to 29.78% of the theoretical yield.

The aromatics selectivity of compounds obtained under helium with each catalyst was similar to that obtained under methane, indicating that methane had no significant effect on the selectivity of particular compounds during catalysis. The variations on aromatics selectivity across different HZSM-5 catalysts were obvious. MoAg/HZSM-5 yielded the highest benzene selectivity, which reached up to 24.53 and 26.97% under helium and methane atmosphere, respectively. In return, the lowest selectivity of xylenes was also observed for MoAg/HZSM-5. Also, MoAg/HZSM-5 yielded the lowest selectivities of benzene derivatives and ethylbenzene among all the molybdenum modified catalysts. These results indicated that the active sites provided by Ag in MoAg/HZSM-5 system were responsible for the dealkylation of alkylated aromatics into benzene. Precious metal such as Pt, Pd and Ag are highly active for hydrogenation reactions. The detailed reaction mechanism involves cleavage of alkyl side chains and simultaneous hydrogenation. In addition, the highest selectivity for polyaromatics was obtained with only the support, indicating that impregnation of metals could have suppressed polymerization of aromatics, leading to polyaromatics or coke deposition.

The results of aromatics carbon yield show that single molybdenum modified HZSM-5 catalysts are not effective in catalyzing breakage of C—H bond in methane. The bimetallic catalysts (MoAg/HZSM-5 and MoZn/HZSM-5) behave as a bifunctional catalyst during the co-catalysis of biomass and methane. The HZSM-5 framework is mainly responsible for cracking of biomass-derived volatiles through a series of dehydration, decarboxylation, decarbonylation and oligomerization reactions to form aromatics. Whereas, the metals, especially the Ag and Zn species, provide active sites for methane activation, resulting in methyl radicals that can incorporate into the structure of biomass-derived organics, thus increase organics available for aromatization in the HZSM-5 channel. The aromatics yield with Mo—Ag was lower than that with Mo—Zn, but benzene selectivity followed opposite trend. This might be the outcome of competition between methane activation and hydrodealkylation of alkylated benzenes, since Ag provides active sites for both reactions. The reaction equations indicated a carbon loss in the form of alkanes through dealkylation, and this might explain why the total yield of aromatics in presence of Mo—Ag loaded catalyst is lower than that in presence of Mo—Zn loaded one. Therefore, taking the catalytic reactivity and aromatic loss into consideration, MoZn/HZSM-5 showed the best catalytic performance in co-conversion of biomass and methane.

With respect to the effect of pyrolysis temperature on the carbon yield of different groups of aromatics from raw switchgrass catalysis in presence of MoZn/HZSM-5, the increase in temperature increased the carbon yield of aromatics at temperature starting from 400 and reached to peak at 700° C. and then dropped. Methane outperformed helium in producing aromatics across the whole reaction temperature range. In addition, the gap of the total aromatics yield between helium and methane also increased as the reaction temperature increased and maximized at 600° C. (71%). These results indicated that methane activation through incorporation with biomass catalysis could occur at a temperature (400° C.) much lower than that required in methane aromatization (700° C.). The synergistic effects of methane and biomass pyrolysis in promoting the yield and H/C ratio of bio-oil using Zn and Ag loaded catalysts at a lower temperature range of 300 to 600° C.

The trends of different aromatic groups such as BTEX, polyaromatics and benzene derivatives versus temperature were similar to that of total aromatics. The sensitivity of carbon yield towards reaction temperature declined in the order of BTEX>polyaromatics>benzene derivatives.

According to the current embodiment, benzene selectivity increased steadily across the whole reaction temperature. Also, the difference between helium and methane atmosphere was not significant until the temperature reached 800° C. Toluene selectivity, fluctuating from 27.01 (400° C. under helium) to 29.10% (600° C. under methane), was not sensitive to reaction temperature. However, reaction atmosphere does seem to affect toluene selectivity. The selectivity of alkylated benzenes other than toluene, including ethylbenzene and xylenes, decreased as the reaction temperature increased. The opposite trends of benzene and C₈ alkylated benzenes with temperature suggested that dealkylation reactions were favored thermally, thus the equilibrium was driven forward to produce more benzene when temperature increased. Benzene derivatives selectivity decreased sharply when temperature increased from 400 to 500° C. followed by no noticeable variation until 700° C. under both helium and methane atmosphere. At 800° C., methane yielded even lower selectivity than that from 700° C., whereas helium still yielded similar selectivity with that from 500 to 700° C. The selectivity of polyaromatics increased gradually and peaked at 700° C. It was worth noting that the selectivity of polyaromatics under methane was lower than that under helium when temperature was equal to or higher than 600° C. Polyaromatic compound, formed by the oligomerization of aromatic rings is considered as an indicator of catalyst coking. The results suggest that incorporation of methane into biomass catalysis pyrolysis could reduce the generation of polyaromatics and thus undermine catalyst coking.

Raw switchgrass, switchgrass torrefied at 230° C. and switchgrass torrefied at 270° C. were pyrolyzed at 700° C. in the presence of MoZn/HZSM-5 catalyst and methane. The torrefied switchgrass did not yield more aromatics than raw switchgrass as expected, and the maximum aromatics carbon yield of 39.31% was obtained from raw switchgrass under methane atmosphere. Furthermore, the aromatics carbon yield decreased sharply as the torrefaction temperature increased from 230 to 270° C. In contrast, oxygenates yield decreased as the torrefaction temperature increased. Similar to raw switchgrass, the carbon yield of different groups of aromatics and total aromatics derived from torrefied switchgrass was also affected by co-feeding methane. However, the increase in aromatics carbon yield due to incorporation of methane decreased as the torrefaction temperature increased. The aromatics carbon yield from switchgrass torrefied at 230° C. was 22.40% in helium, compared with 27.49% in methane atmosphere. Similarly, the aromatics carbon yield from switchgrass torrefied at 270° C. increased from 13.73 to 18.17% when pyrolysis environment switched from helium to methane. The torrefied pine wood yielded a BTEX of 13.13%, which was less than BTEX yield of 15.62% obtained from switchgrass in the current embodiment. However, aromatics carbon yield of 26.68% obtained from torrefied pine wood was higher than that of 22.40% obtained from switchgrass torrefied at 230° C. The difference in aromatics carbon yield from switchgrass and pine wood with similar torrefaction severity could be attributed to the difference in reaction temperature or the difference in catalyst reactivity. Our results confirm that MoZn/HZSM-5 increased yield and selectivity of BTEX (targeted aromatic hydrocarbons) as compared to only HZSM-5.

With respect to the aromatics selectivity of raw and torrefied switchgrass in both helium and methane atmosphere, no difference in aromatics selectivity was observed between helium and methane. The selectivity of BTEX from catalytic pyrolysis under helium was 67.91% for raw switchgrass, compared with 70.69 and 75.25% for switchgrass torrefied at 230 and 270° C., respectively. For instance, the selectivity of benzene and toluene from catalysis of raw switchgrass under helium was 18.40 and 27.52%, respectively. As the torrefaction temperature increased, the selectivity of benzene and toluene under helium increased from 20.21 and 29.21%, respectively, at torrefaction temperature of 230° C. to 21.10 and 31.46%, respectively, at torrefaction temperature of 270° C. On the contrary, the selectivity of polyaromatics and benzene derivatives declined in the order of raw switchgrass>switchgrass torrefied at 230° C.>switchgrass torrefied at 270° C. The variation in aromatics selectivity with torrefaction and torrefaction temperature are consistent with that reported in literature.

The correlation between contents of biomass major components (cellulose, hemicellulose and lignin) and its aromatics carbon yield from the catalytic pyrolysis, biomass components indicates that the contents of two carbohydrates (cellulose and hemicellulose) were correlated positively with the aromatics carbon yield. In contrast, content of lignin negatively correlated with the aromatics yield. These results suggest that aromatics yield from biomass components follow the order of cellulose>hemicellulose>lignin, which is consistent with the findings reported in previous studies. Therefore, the lower aromatics yield obtained from torrefied switchgrass (as compared to raw switchgrass) could be attributed to the decrease in cellulose content and increase in lignin content during torrefaction. In order to maximize the aromatics yield from torrefied biomass, torrefaction reactor design and conditions should be optimized to increase the cellulose fraction and decrease the lignin fraction.

Co-catalysis of torrefied switchgrass and methane was investigated over molybdenum modified HZSM-5 catalysts. Bimetallic catalysts (MoAg/HZSM-5 and MoZn/HZSM-5) were more effective in catalyzing methane activation than molybdenum-only loaded (MoO₃/HZSM-5 and Mo₂C/HZSM-5) catalysts. A maximum aromatics yield obtained from raw switchgrass under methane atmosphere in presence of MoZn/HZSM-5 was 39.31%, which was 33% higher than that under helium atmosphere. Methane incorporation increased aromatics yield by up to 71% at 600° C. However, torrefaction pretreatment did not increase the aromatics yield due to the reduced cellulose content and increased lignin content during torrefaction. The aromatic yield is highly dependent on the relative contents of cellulose, hemicellulose and lignin in biomass samples. Aromatic yield follows the trend of cellulose>hemicellulose>lignin.

Catalytic pyrolysis experiments of biomass model components were carried out in a commercial micro pyrolyzer. About 0.5 mg biomass model samples and 2.5 mg catalysts were loaded into a quartz tube and separated into two layers with quartz wool. The samples were heated to 650° C. at a filament heating rate of 1000° C./s and then held at that temperature for 15 seconds. The produced volatiles were analyzed with a gas chromatography/mass spectrometry system connected to the pyroprobe by a transfer line. The chromatographic separation was performed using a DB-5 capillary column (30 mL×0.32 mm I.D., 0.25 μm film thickness). The GC oven was be held at 40° C. for 4 min, and the temperature was then increased to 280° C. at a ramping rate of 5° C./min and held for 20 min. The injector temperature was 250° C., and the split ratio was set to 30:1. Helium (purity: 99.99%) was used as the carrier gas at a flow rate of 1 mL/min.

Quantification of targeted compounds was performed after calibration by injecting different known concentrations of working standards into the GC/MS. The carbon yield and selectivity was calculated using the equations set out previously.

Analysis of non-condensable gases was conducted in a separate experiment following the same procedure as described above without using the adsorbent trap. A fused silica capillary column, 30 m×0.53 mm, average thickness 30 μm was used. The quantification of gases was performed after calibration using known standard gas mixture consists of H₂, CO, CO₂, CH₄, C₂H₄, C₂H₆, C₃H₈ and n-C₄H₁₀ in helium.

A full factorial design was used with three independent parameters: two pyrolytic atmospheres (helium and methane), three biomass components (cellulose, hemicellulose and lignin) and three impregnated metals (None, Fe and Mo). All the experiments were be replicated. The average and standard deviation are used to compare carbon yields and selectivity.

Continuing with another embodiment, torrefaction pretreatment and co-pyrolysis are combined with methane to improve the aromatics yields of biomass CFP process. Both torrefaction pretreatment and co-feeding of methane will improve the H/C_{eff} ratio of the reactant, which would result in high aromatics yield. In addition, coupling effects of methane dehydroaromatization and biomass-derived oxygenates upgrading over ZSM-5 catalysts could also be expected to improve the aromatics yield. The specific objective is to utilize the reaction pathways and reaction kinetics of co-pyrolyzing methane with raw and torrefied biomass feedstocks to selectively improve BTEXN (benzene, toluene, ethylbenzene, xylenes and naphthalene) yield using a selected HZSM-5 catalyst. The effects of torrefaction pretreatment and torrefaction temperature on the product distribution from coupling conversion of biomass and methane will be investigated. Switchgrass and eastern red cedar can be used as the biomass feedstocks.

Switchgrass samples and red cedar wood chips were analyzed. Both the switchgrass and red cedar wood chips were processed in a mill with a screen size of 0.5 mm for size reduction. The moisture, volatile matter and ash contents of biomass sample were determined according to ASAE standard 5358.2, ASTM D3175 and ASTM E1755-01, respectively. The fixed carbon content was calculated by weight percentage difference on dry basis. The ultimate analysis was performed using an elemental analyzer following ASTM D3176. The higher heating value (HHV) was measured with a calorimeter.

Ground switchgrass and red cedar wood were samples were torrefied at 230 and 270° C. in a torrefaction reactor system for 30 min and then exited from the bottom of the reactor through a horizontal auger.

Catalytic pyrolysis of raw and torrefied switchgrass was investigated. As shown in FIGS. 3 and 4, the torrefied switchgrass produced much more aromatic hydrocarbons than the raw switchgrass. In addition, the furfural yield from torrefied switchgrass was significantly lower than that for raw switchgrass. These results indicated that torrefied switchgrass has higher selectivity towards aromatic compounds than raw switchgrass. However, higher torrefaction temperatures did not improve the yield of aromatic hydrocarbons.

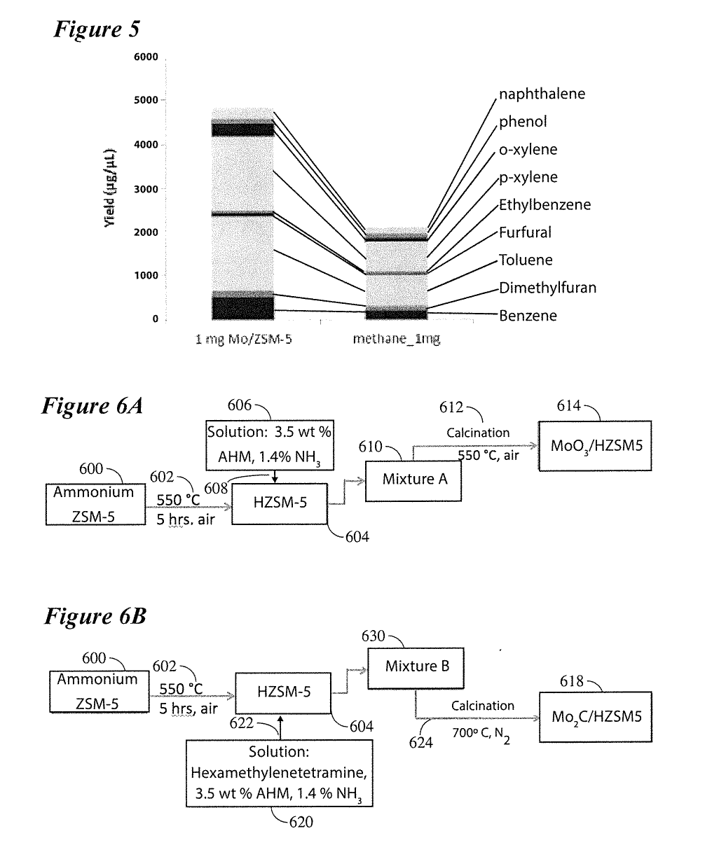

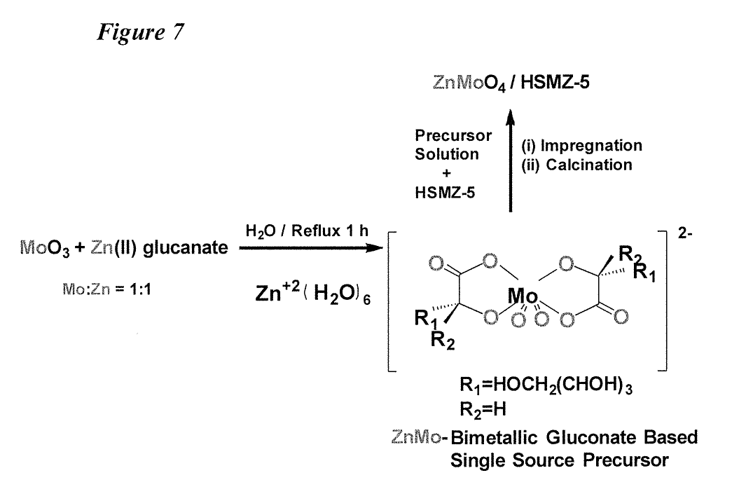

FIG. 5 shows the effect of pyrolysis atmospheres on product yields obtained from pyrolysis of furan at 600° C. The yields of major compounds, such as benzene, toluene, p/o-xylene and naphthalene in methane atmosphere were significantly as compared with those in helium.

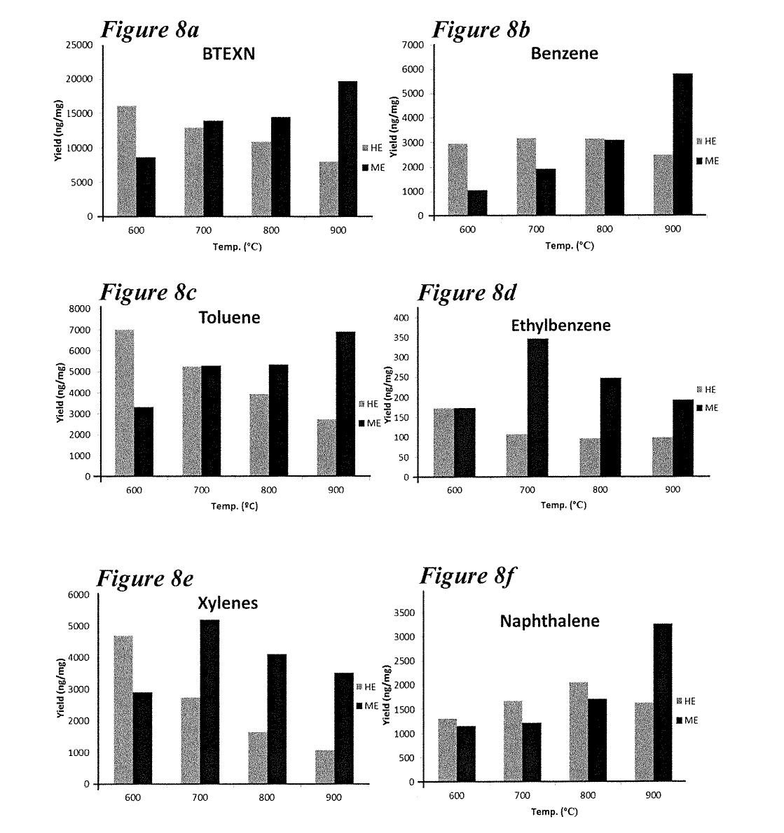

FIGS. 8a-8f show the effects of pyrolysis temperature and pyrolysis atmosphere on the BTEXN (benzene, toluene, ethylbenzene, xylenes and naphthalene) yields obtained from pyrolysis of torrefied switchgrass. The total BTEXN yield decreased as the temperature increased in helium atmosphere while the yield increased significantly in methane atmosphere. Methane outperforms helium in producing BTEXN when temperature is higher than 700° C. Additionally, the impact of pyrolysis atmosphere and temperature on the yield of individual component of BTEXN is distinct. Benzene yield was not very sensitive to the temperature under helium but increased significantly as the temperature increased in a methane atmosphere. Methane outperformed helium to produce higher yield of benzene only at 900° C. Toluene yield decreased with the increasing temperature under helium atmosphere significantly while increased significantly in methane atmosphere. Methane leads to higher toluene yield than helium when the pyrolysis temperature was above 700° C. Methane led to higher yield of ethylbenzene and xylenes than helium in the temperature range of 700 to 900° C. Naphthalene yield under helium atmosphere increased slightly with increasing pyrolysis temperature, reaching a maximum at 800° C., and then decreased whereas, the yield under methane atmosphere increased steadily as the temperature increased. Methane led to higher naphthalene yields than helium only at 900° C. The results indicated that lower temperature pyrolysis (<=700° C.) favored alkylation of simple aromatics (benzene, toluene) forming alkylated aromatics such as ethylbenzene and xylenes with the interaction of methane. However, the alkylation effect was mitigated as the temperature further increased, leading to a decrease in alkylated products and increase in simple aromatics. As discussed earlier, the interaction of biomass pyrolysis and the dehydroaromatization of methane also lead to the increase in simple aromatics. During aromatization of methane, small radicals such as H. and CHₓ (x<4) evolve, and these radicals can be stabilized by the pyrolysis vapors of biomass in the form of aromatic compounds or olefins. In addition, high reaction temperature favors the aromatization of methane thermochemically, leading to the promotion of radicals. These radicals are then stabilized by biomass pyrolysis vapors leading to formation of aromatics.

Inert gases such as helium and nitrogen are frequently used carrier gases in the fast pyrolysis of biomass. Apart from these inert gases, the use of other medium such as steam and CO, CO₂, H₂ and CH₄ are also known. It has been reported that steam could react with solid char leading to an increase in liquid yield, and the addition of steam resulted in more water-soluble compounds than nitrogen. The pyrolysis of corncob in a fluidized bed reactor under N₂, CO₂, CO, CH₄ and H₂ atmospheres and the compositions of liquid products have also been analyzed. The results indicated that CH₄ produced the highest liquid yield among all the gases tested. The bio-oil composition analysis indicated that reduced gases like CO and H₂ produced more deoxygenated compounds than other gases. In addition, CO and CO₂ produced more stabilized liquid products with less methoxyphenols.

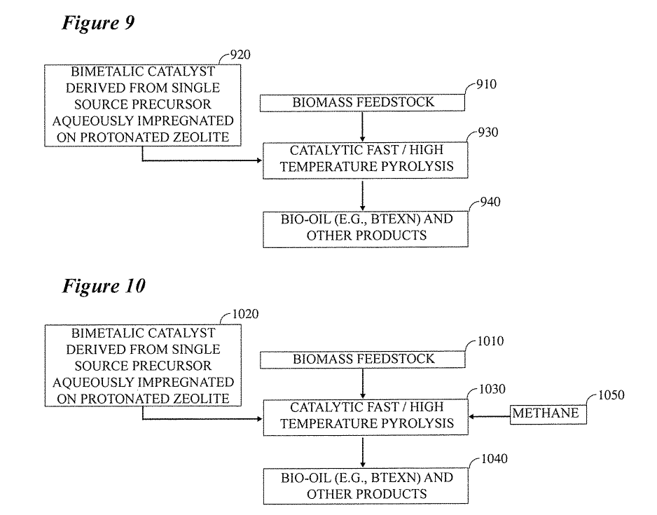

FIGS. 9 and 10 give high level overviews of embodiments of methods discussed herein. Turning first to FIG. 9, this figure illustrates an exemplary process yet involves conversion of biomass feedstock to bio-oil and other products. As is indicated in FIG. 9, box 910 identifies the biomass feedstock which might be by way of example only, harvested plant materials, forest and agricultural wastes, energy crops, animal waste, municipal waste, lignocellulosis material, etc. As is indicated, the biomass feedstock 910 will be subjected to catalytic fast/high temperature pyrolysis (box 930) in the presence of a bimetallic protonated zeolite catalyst (box 920). One output from that product will be bio-oil and other products (box 940) as discussed herein.

FIG. 10 illustrates an embodiment where in the biomass feedstock 1010 is subjected to catalytic high temperature pyrolysis 1030 in the presence of methane 1050. This also will take place in the presence of the bimetallic protonated zeolite catalyst 1020 and will result in the production of bio-oil and other products (box 1040) as discussed herein.

Finally, it should be noted that, although the disclosure presented above has primarily referred to methane, various embodiments of the invention could also apply to other volatile hydrocarbons such as ethane, ethylene, and propane. Further, the techniques taught herein invention will directly use natural gas (primarily composed of methane) and petroleum off-gases (primarily composed of volatile hydrocarbons).

By way of summary of various embodiments, torrefaction of switchgrass increased the total aromatic hydrocarbons yield by two times but lowered furfural yield. Monocyclic aromatic compounds such as toluene, p and o-xylene increased significantly with increase in catalyst loading. However, increase in the torrefaction temperature from 230 to 270° C. decreased the aromatic hydrocarbons yield. These results clearly indicate that torrefied biomass were much more reactive and could produce much higher liquid hydrocarbon yield when facilitated by appropriate reaction conditions and catalysts.

The presence of methane and levels of pyrolysis temperature appear to have interaction effects on yields of aromatic hydrocarbons. With furan as the substrate, presence of methane decreased the major compounds, such as benzene, toluene, p/o-xylene and naphthalene as compared to those obtained in pyrolysis in a helium atmosphere. As pyrolysis temperature increased (from 600 to 900° C.), the total BTEXN (benzene, toluene, ethylbenzene, xylenes and naphthalene) yield decreased in the helium atmosphere but they increased significantly in the methane atmosphere.

Methane outperformed helium in producing BTEXN when the temperature was equal to or above 700° C. Additionally, the effects of pyrolysis atmosphere and temperature on the yield of individual components were distinct in the two atmospheres. Benzene yield was not sensitive to the temperature change in the helium atmosphere. However, the benzene yield increased significantly as the temperature increased in the methane atmosphere. Toluene yield decreased with the increasing temperature in the helium atmosphere while increased considerably in the methane atmosphere.

Toluene yield in the methane atmosphere was higher than that in the helium atmosphere when the pyrolysis temperature was equal to or above 700° C. Ethylbenzene and xylenes yield in the methane atmosphere was higher than those in the helium at temperature of 700 to 900° C. Naphthalene yield under helium atmosphere increased slightly and reached a maximum at 800° C., and then decreased whereas, the naphthalene yield under methane atmosphere increased steadily as the temperature increased. The naphthalene yield was higher in methane atmosphere than that in helium atmosphere only at 900° C.

Lower temperature pyrolysis (<=700° C.) favored alkylation of simple aromatics (benzene, toluene) into alkylated aromatics such as ethylbenzene and xylenes with the interaction of methane. However, the alkylation effect was mitigated as the temperature further increased, resulting in a decrease of alkylated products and increase in simple aromatics. The interaction of biomass pyrolysis and the dehydroaromatization of methane also leads to the increase of simple aromatics. During aromatization of methane, small radicals such as H. and CHₓ (x<4) were evolved, and these radicals are stabilized by the pyrolysis vapors of biomass in the form of aromatic compounds or olefins. In addition, high reaction temperature favors the aromatization of methane, leading to the promotion of radicals, therefore increasing the opportunity of being stabilized by the biomass pyrolysis vapors and thus high reaction temperature appears to contribute to the increase in aromatics.

Monocyclic and polycyclic aromatics were found to be the dominant species in the pyrolysis products of dimethylfuran with Mo/ZSM-5. With Mo/ZSM-5 and Ni—Mo/Al₂O₃, toluene and p-xylene accounted for the largest proportion of the aromatic hydrocarbons. As the catalyst loading increased, the yield of monocyclic aromatic hydrocarbons (benzene, toluene, p/o-xylene and ethylbenzene) increased. However, the aromatic hydrocarbon yields using the Ni—Mo/Al₂O₃ catalyst were much lower than those using the Mo/ZSM-5 catalyst.

Hypo phosphorous acid showed a strong catalytic reactivity towards aromatics. Monocyclic and polycyclic (n<=3) aromatics were dominant species in the pyrolysis products of torrefied switchgrass with hypo phosphorous acid. The addition of phosphoric acid promoted the dehydration and aromatization reactions during pyrolysis conditions. Among all other metal oxides catalysts that were selected, FeMoO₄ showed the best selectivity for aromatics in certain embodiments.

With respect to the effects of torrefaction and densification on pyrolysis products of switchgrass, the torrefaction of switchgrass improved its oxygen to carbon ratio and energy content. Contents of anhydrous sugars and phenols in pyrolysis products of torrefied switchgrass were higher than those in pyrolysis products of raw switchgrass. As the torrefaction temperature increased from 230 to 270° C., the contents of anhydrous sugars and phenols in pyrolysis products increased whereas content of guaiacols decreased. High pyrolysis temperature (600 and 700° C. as compared to 500° C.) enhanced decomposition of lignin and anhydrous sugars, leading to increases in phenols, aromatics and furans. Densification enhanced depolymerization of cellulose and hemicellulose during pyrolysis.

Finally, various embodiments disclosed herein concern the catalytic pyrolysis of three biomass constituents (cellulose, hemicellulose and lignin) under both helium and methane atmospheres in the presence of HZSM-5 and HZSM-5 supported molybdenum-based catalysts. Cellulose contributed most to the production of aromatic hydrocarbons followed by hemicellulose and lignin. The introduction of methane enhanced hydrodeoxygenation of lignin-derived phenols leading to increased aromatics yield in presence of HZSM-5 zeolites. The carbon yield of total aromatics from lignin increased from 12.8 to 15.13% when pyrolysis atmosphere changed from helium to methane in presence of HZSM-5 support. However, methane was not generally effective in improving the aromatics yield from cellulose and hemicellulose. The active sites provided by Mo species facilitated the deoxygenation of lignin-derived phenols and thus inhibited the production of polyaromatics and coke.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A catalyst for the pyrolysis of biomass, the catalyst comprising:
a bimetallic catalyst impregnated onto a protonated zeolite, said bimetallic catalyst comprising a first metal component and a secondary metal component.

2. The catalyst of claim 1 wherein said first metal component is selected from the group consisting of molybdenum oxide or carbonate, vanadium oxide or carbonate and tungsten oxide or carbonate.

3. The catalyst of claim 1 wherein said first metal component is molybdenum oxide or molybdenum carbonate.

4. The catalyst according to claim 1, wherein said secondary metal component is selected from the group consisting of zinc, silver, a divalent transition metal and an alkaline earth metal.

5. The catalyst according to claim 1, wherein said secondary metal component is selected from the group consisting of silver and zinc.

6. The catalyst according to claim 1, wherein said secondary metal component is zinc.

7. The catalyst according to claim 1, wherein said protonated zeolite is protonated ZSM-5.

8. The catalyst according to claim 1 wherein said catalyst is MoAg/HZSM-5 or MoZn/HZSM-5.

9. A method of preparing a catalyst for use in the pyrolysis of biomass, comprising the steps of:
a. preparing a protonated form of zeolite ZSM-5;
b. impregnating said protonated zeolite ZSM-5 with a bimetallic catalyst; and
c. calcining said impregnated protonated zeolite ZSM-5, thereby producing said catalyst.

10. The method according to claim 9, wherein said bimetallic catalyst comprises a first metal component and a secondary metal component.

11. The catalyst of claim 9 wherein said first metal component is selected from the group consisting of molybdenum oxide or carbonate, vanadium oxide or carbonate and tungsten oxide or carbonate.

12. The catalyst of claim 9 wherein said first metal component is molybdenum oxide or molybdenum carbonate.

13. The method according to claim 9, wherein said bimetallic catalyst is in an aqueous solution.

14. The catalyst according to claim 9, wherein said secondary metal component is selected from the group consisting of zinc, silver, a divalent transition metal and an alkaline earth metal.

15. The catalyst according to claim 10, wherein said secondary metal component is zinc.

16. A method for producing bio-oil from a biomass, comprising the steps of:
co-pyrolyzing said biomass and methane atmosphere at a high temperature in the presence of a catalyst.

17. The method according to claim 16, wherein said catalyst is a molybdenum oxide or molybdenum carbide impregnated onto a protonated zeolite.

18. The method according to claim 17, wherein said protonated zeolite is protonated ZSM-5.

19. The method according to claim 16, wherein said catalyst is a bimetallic catalyst impregnated onto a protonated zeolite.

20. The method according to claim 19, wherein said protonated zeolite is protonated ZSM-5.

21. The method according to claim 16, wherein said catalyst is MoAg/HZSM-5 or MoZn/HZSM-5.

22. A method for producing bio-oil from a biomass, comprising the step of:
pyrolyzing said biomass in the presence of a catalyst, said catalyst comprising a bimetallic catalyst impregnated onto a protonated zeolite.

23. The method according to claim 22, wherein said bimetallic catalyst is MoAg/HZSM-5 or MoZn/HZSM-5.

24. The method according to claim 22, wherein said bimetallic catalyst is aqueously impregnated onto the zeolite.

25. The method according to claim 21, wherein said bimetallic catalyst is formed from a single source precursor.
